(19) United States
(12) Patent Application Publication
(10) Pub. No.: US 2012/0077382 A1
(43) Pub. Date: Mar. 29, 2012

(54) PROCESS FOR MANUFACTURING A SPARK PLUG CABLE AND RESULTING ARTICLE OF MANUFACTURE

(76) Inventor: Luiz Philippe De Orleans E Bragança, Caninde (BR)

(21) Appl. No.: 13/219,098

(22) Filed: Aug. 26, 2011

(30) Foreign Application Priority Data
Aug. 26, 2010 (BR) PI 1003129-4
Dec. 15, 2010 (BR) 018100047666
Dec. 15, 2010 (BR) 018100047667
May 6, 2011 (BR) 018110017024

(51) Int. Cl. H01R 13/66; H01R 43/16; H01R 43/00

(52) U.S. Cl. 439/620.21; 29/854; 29/874

(57) ABSTRACT

Process for assembly of a diode in a spark plug cable of an internal combustion engine, suppression spark plug cable connector, manufacturing process of a suppression spark plug cable connector, spark plug connector and spark plug connection socket of internal combustion engines, said process being part of a spark plug cable (2) which is cut and receives a pipe sector (7) assembly inside which a diode (8) is located, the pipe (7) is bond between segments (2′) and (2″) of the spark plug cable (2) and receives around it a pipe-bridge (4) and a heat shrinkable cover (5); the connector (A1) featuring a diode (A2) in its inside, mounted in an encapsulated way (A2′); another connector (B1) being provided as a main cylindrical body (B2) made of injected material inside which two metal inserts (B3) are mounted in a centralized and mutual opposition arrangement, each of said inserts having a mutual contact terminal (B4) and in its respective opposite ends, a self-tapping-shaped screw terminal (B5); the socket (C1) providing mounting a diode (C10) previously encapsulated in an injected coating (C11), said diode (C10) and its coating (C12) being arranged inside a second portion (C12) of core (C5) of the socket (C1).

### BACKGROUND OF THE INVENTION

1. Field of the Invention

This description relates to a process for assembling a diode in a spark plug cable used with internal combustion engines, including those used in engines for motorcycles and related vehicles. The process herein may also be used in internal combustion engines for cars and other similar vehicles.

The present invention further correlatively refers to a connector specially designed to be used together with a suppression spark plug cable for internal combustion engines, which may be both resistive cables, a modality used in most cars and similar vehicles, and non-resistive cables used in motorcycles and related vehicles, and the referred invention further relates to a manufacturing process of the spark plug cable connector disclosed herein, and said suppression spark plug cable connector having a diode.

The present invention further provides a suppression/non-resistive spark plug cable connector, which is intended to allow both the electric connection between two cable sectors, and also, in a simple and effective way, such union to take place in a condition under which an ideal mechanical resistance is established.

Still in a related way, the present invention refers to a socket for connection of spark plugs for internal combustion engines, and more specifically, but not solely, a socket to be used in engines for motorcycles and related vehicles. The present patent application provides a socket structure featuring a diode whose function is to improve the electrical current conduction performance, and as a result, improve air/fuel mixture burning ignited by the spark produced by the spark plug.

2. Description of the Related Art

As generally known in the art, internal combustion engines, more specifically Otto cycle engines and similar ones, use a spark plug to produce a spark that ignites the air/fuel mixture inside the cylinder, thus causing the explosion of such mixture, and consequent displacement of the piston, which then starts the generation of the required work power.

Spark plugs are electric components connected to an electric pulse generating source (coil) through a flexible cable featuring in its end a terminal (socket) which may be connected to the spark plug terminal itself.

The opposite end of the spark plug comprises a terminal having an external thread which can be mounted to an opening having likewise a thread and which is provided in the engine block in direct relationship with the cylinder, said terminal being screwed to the end where electrodes are provided to generate a spark whenever the spark plug is electrically fed by the coil.

Generally speaking, the functional characteristics of spark plugs are determined by its material, gap and design of the electrodes included therein.

Still referring to the current state of the art, a technique is known according to which a spark plug cable is provided with a diode whose function is to improve the conditions of the electrical current supplied to the spark plug, thus enabling the spark plug to have a better performance, and improving, as a consequence, the engine performance characteristics which are directly related to the efficiency of the air/fuel mixture burning.

This technique of assembling a diode in the spark plug cable comprises using rubber connectors aiming at protecting the points of electric contact between the connector and the cable itself, and such type of connector is also used to protect the connection region between the spark plug cable and the terminal.

Irrespective of the effective level of performance improvement obtained with the use of the diode, the type of mounting usually adopted to include such component has the disadvantage of allowing points or regions of where the current leakage phenomenon may occur, and this is a phenomenon that must be completely prevented not only because of the simple matter of losing efficiency regarding the level of energy sent out to the spark plug, but also due to the risk of accident in case such defective cable is handled while the engine is in operation.

In view of the above drawback, the present invention has been developed and relates to a process for assembly of a diode in a spark plug ignition cable of an internal combustion engine, whose process enables, through simple steps, assembling such diode in the ignition wire in such a way that it primarily avoids the occurrence of current leakage.

### SUMMARY OF THE INVENTION

The process disclosed herein comprises taking the spark plug cable as originally produced and having its structure cut in order to provide a location where a diode unit previously housed inside a detached pipe sector will be positioned.

The process disclosed herein further provides using an adhesive layer applied between the junction point between each of the sectioned ends of the spark plug cable and the corresponding ends of the pipe sector used to house the diode, and after such bonding step is complete, another pipe sector called pipe-bridge, is mounted around the section comprising the sectioned ends of the spark plug cable and the diode-holder pipe sector, around which a heat shrinkable plastic cover is then mounted.

The above-described assembly allows for fully including the diode into the spark plug in a condition such that it primarily avoids the possibility of current leakage.

The present process provides a first variation, according to which the diode is previously encapsulated through an overinjection process, and such previously encapsulated diode is then mounted between the ends of the two spark plug wire segments, to which it is glued and then coated with a resin layer. After the diode is coated with the resin layer, the pipe-bridge is mounted and then receives a heat shrinkable cover.

The present process further provides a second variation, according to which the diode is directly glued to the sectioned ends of the spark plug cable, and then a pipe-pipe bridge is set to finish its mounting.

Still referring to the art, and in parallel thereto, the present invention further provides a suppression spark plug cable connector and its manufacturing process, and such connector being intended to improve the type of assembly process usually employed in the art to include such component, such assembly having the disadvantage of allowing points or regions where the current leakage phenomenon occurs, a phenomenon that must be completely avoided not only because of the simple matter of losing efficiency regarding the level of energy sent out to the spark plug, but also due to the risk of accident in case such defective cable is handled while the engine is in operation.

The connector provided in this application includes a diode, which is initially coated with a cover obtained by injection process to encapsulate said diode.

The present invention further discloses a process for manufacturing the connector provided herein, which enables to obtain an effective component in order to allow the best use possible of the current that crosses the diode assembly and goes towards the spark plug, and the present process further provides the initial step of encapsulating a diode unit by a coating it through an injection process, and the encapsulated diode is then mounted in a mold where a second injection process is carried out to build the connector body itself.

Still referring to another aspect of the current state of the art, this invention further provides a connector which has been developed in view of the present art that provides a technique according to which a suppression spark plug cable may be provided with a diode whose function is to improve the conditions of the electric current supplied to the spark plug at each ignition cycle, thus resulting in a better performance of the spark plug, and as a result, improving the performance characteristics of the engine which are directly related to the efficiency of the air/fuel mixture burning inside the cylinder.

This technique of assembling a diode in the suppression spark plug wire cable comprises, in certain cases, the need of cutting the original spark plug wire cable and replacing a section thereof with another where the diode is already fitted, and in the end, the capacity of current transmission of the cable itself to the spark plug needs to be restored, then passing, in this case, through the diode.

The restoration of the original spark plug cable, after it has been cut, is not a quite simple or easy task, because in addition to establishing a suitable electrical connection, the solution used to achieve such restoration must also allow obtaining the suitable mechanical resistance that said cable must have.

In view of the above drawbacks, the present connector has been developed, whose function is to assemble and fit the devices to a suppression spark plug cable of internal combustion engines, particularly regarding engines of motorcycles and related vehicles, and such spark plug cables are then capable of receiving, for example, the increment of devices featuring a diode.

The connector disclosed herein is essentially defined as a main cylindrical body made of injected material, inside which two metal inserts are mounted in a centralized and mutual opposition arrangement, each of them featuring a mutual contact terminal and a self-tapping screw shaped terminal at the opposite end.

The connector provided herein makes simpler joining the two spark plug cable sectors, as it allows, without requiring any tool or instrument, introducing the ends of that type of cable in each of the ends of its main body, thus contacting the respective self-tapping screw spindle shaped terminals which are part of the two metal inserts which are kept trapped in the central portion of the connector.

Finally, the present invention further provides, in respect of the provisions of the related art, a socket which differs from the state of the art sockets because it provides including a diode into the socket structure used in spark plug cables suitable for certain internal combustion engines, and particularly used in a wide range of spark plug cables used in engines of motorcycles and related vehicles.

The assembly of the diode in the socket brings up a number of advantages over the state of the art, among them the following can be cited: the possibility of reducing the dimensions of the spark plug cable, as the diode is assembled in the socket structure itself; greater simplicity in the manufacture of the spark plug cable as a whole, as it usually already aggregates other components (spark plug connector and resistor) and would then receive one more component; reduced costs for the assembly of the diode, as it is mounted in such way to be suitably positioned before injection of the socket structure; possibility of replacing the original sockets; easier installation in the ignition system; and an even greater reduction in the possibility of current loss or leakage (as the diode is encapsulated in the socket structure).

### BRIEF DESCRIPTION OF THE DRAWINGS

The present invention may be understood with the drawings described below, in which:

FIG. 1 shows a schematic view of a typical configuration of a coil, a spark plug cable and a spark plug, said view further schematically showing the assembly sequence of such components

FIGS. 2, 2A, 2B, 2C, 2D and 2E show schematically and sequentially the steps provided in the main version of the mounting process described herein, whose steps start with the spark plug cable still in its original state and end with the diode fully assembled in the structure of said spark plug cable.

FIG. 3 also shows schematically and in accordance with the main version of this process, a general section of the spark plug cable, where the diode was mounted, and whose section allows viewing the aggregate of all components used to render such mounting practical.

FIG. 4 further shows schematically, an assembly consisting of a coil, spark plug cable and spark plug, where a diode unit was duly assembled by using the main version of the process disclosed herein.

FIGS. 5, 5A, 5B, 5C and 5D show schematically and sequentially the steps provided in a first variation of the main version of the assembly process described herein, whose steps start with the spark plug cable still in its original state and end with the diode fully assembled in the structure of said spark plug cable.

FIG. 6 also shows schematically and in accordance with the first variation (another embodiment) of the main version of this process, a general section of the spark plug cable, where the diode was mounted, and whose section allows viewing the aggregate of all components used to render such mounting practical.

FIGS. 7, 7A, 7B, 7C and 7D show schematically and sequentially the steps provided in a second variation of the main version of the assembly process described herein, whose steps start with the spark plug cable still in its original state and end with the diode fully assembled in the structure of said spark plug cable.

FIG. 8 further shows, schematically, a general section of the spark plug cable, where a diode was mounted according to the second variation of the main version of the process disclosed herein.

FIG. 9 shows a schematic view of the manufacturing process of the connector disclosed herein.

FIG. 10 shows a side view of the connector provided herein.

FIG. 11 shows a section line “A”-“A” of FIG. 10.

FIG. 12 shows a schematic view illustrating the assembly of the connector disclosed herein.

FIG. 12A shows a schematic view of another connector modality disclosed herein deriving from the solution shown in FIG. 12, which features a “powder fuse”-like head terminal (resistive).

FIGS. 13 and 14 show two other variations of the connector object of this invention, in which FIG. 13 shows a connector modality intended to be used with suppression, non-resistive spark plug cables in motorcycles and similar vehicles, while FIG. 14 shows another variation of said connector, which is intended to be used with resistive suppression spark plugs in automobiles and similar vehicles.

FIG. 15 shows the connector disclosed herein assembled in a suppression spark plug cable.

FIG. 15A shows an enlarged and schematically sectional detail taken of FIG. 15.

FIG. 16 shows a perspective view of the connector disclosed herein.

FIG. 17 shows a longitudinal section of the connector disclosed herein, such as shown by the section line “A”-“A” of FIG. 16.

FIG. 18 shows a sectional and schematic view illustrating said connector mounted between two sectors of the spark plug cable, and in one of its sides, the connector already includes a sector of the spark plug cable suitably coupled, while at its opposite end, the other sector of the spark plug cable to be joined is shown slightly apart.

FIG. 19 shows a perspective and schematic section view of an embodiment of the socket disclosed herein.

### DETAILED DESCRIPTION OF THE EMBODIMENTS OF THE INVENTION

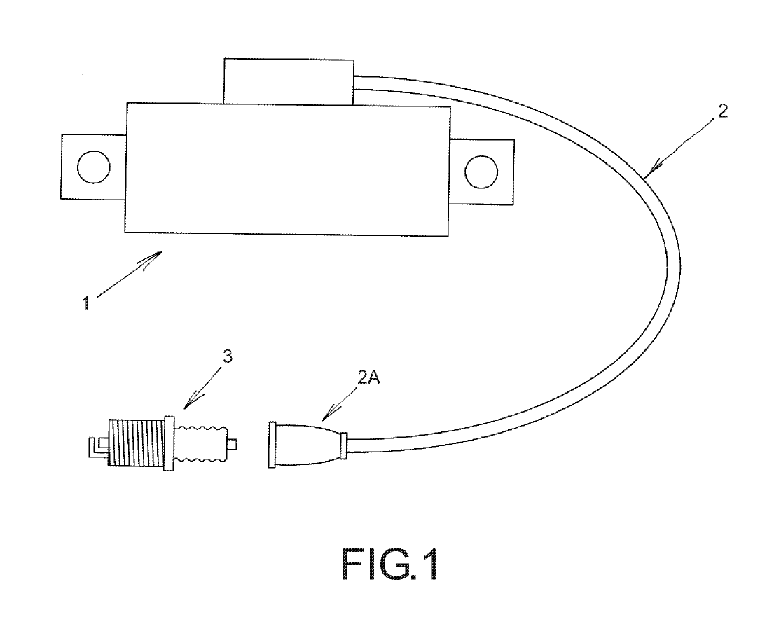

According to what is shown in the above-mentioned figures, the assembly process of a diode in a spark plug cable of an internal combustion engine, such as that provided in this invention, comprises a power supply system used in internal combustion engines, said system being schematically shown in FIG. 1, where three basic components are typically used, as follows: a) a coil unit; b) a spark plug cable; and c) a spark plug.

FIG. 1 shows a schematic view of a typical configuration, such as mentioned above, in which a coil 1, a spark plug cable 2 and its corresponding terminal (socket) 2A are shown in addition to a spark plug 3.

The purpose of said FIG. 1 is to illustrate a general view of the logic assembly sequence of said components.

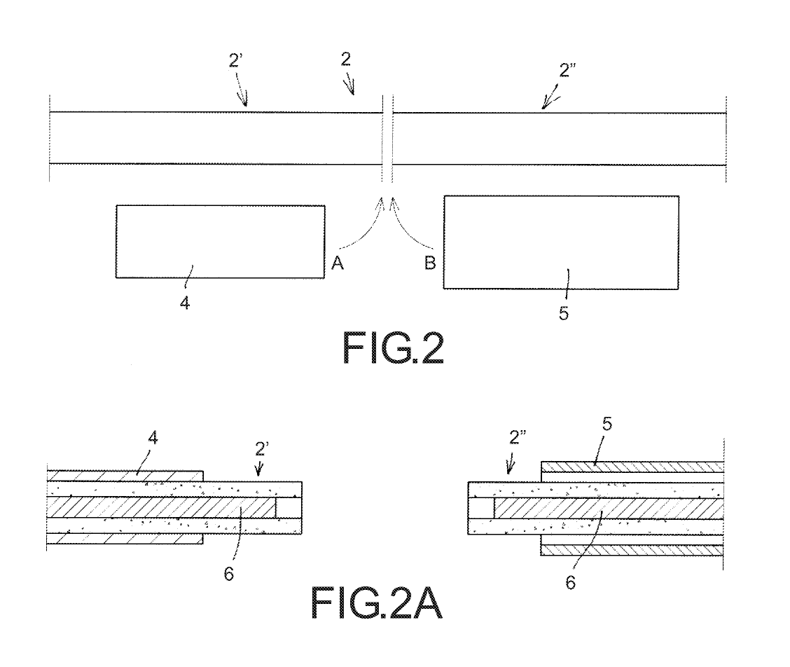

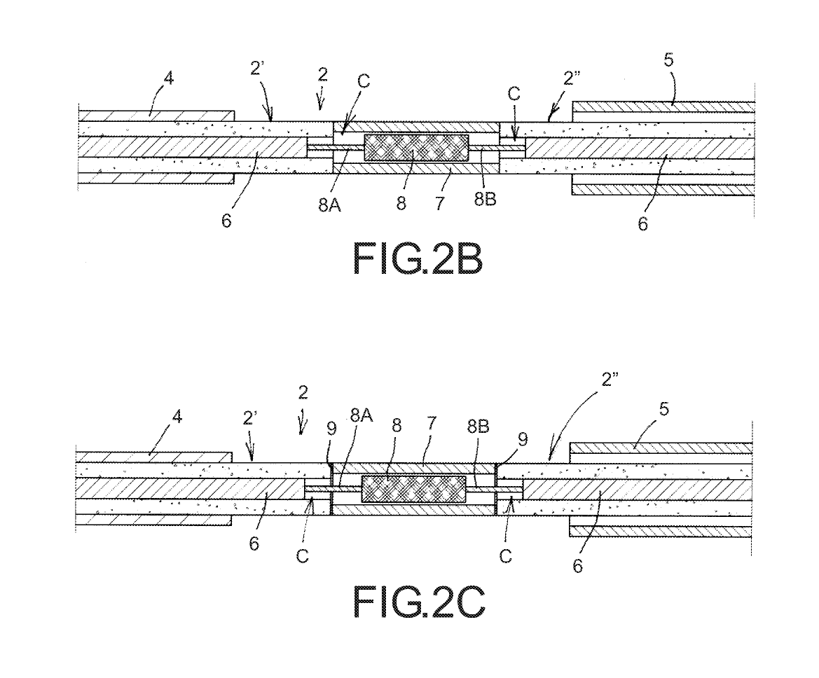

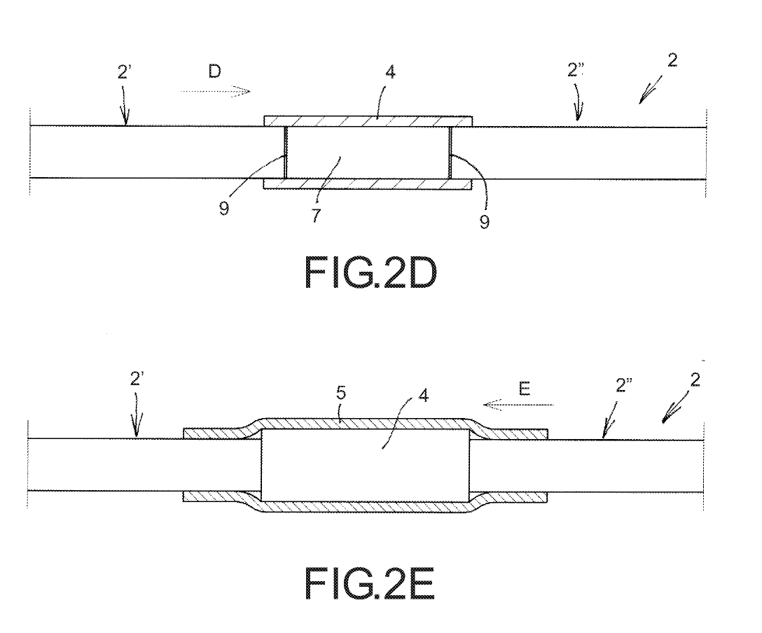

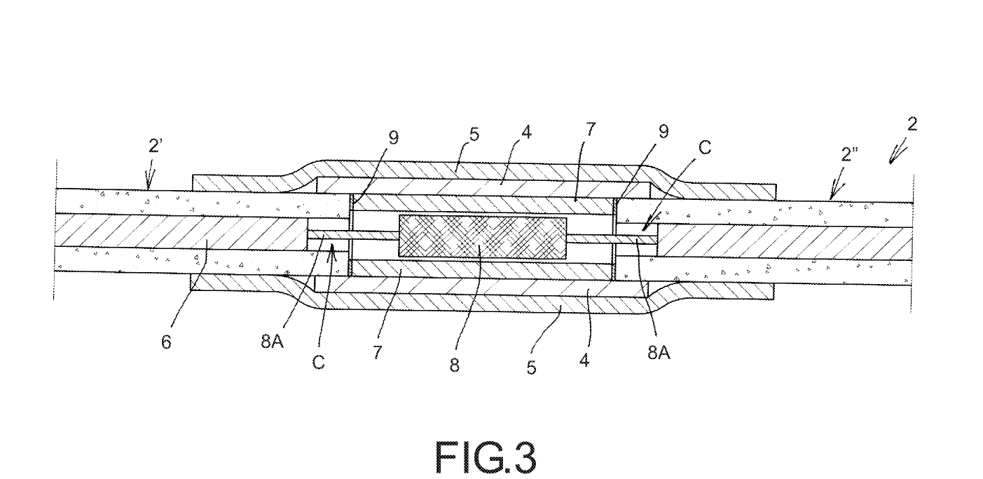

The present invention relates to a process for assembly of a diode, whose process starts by arranging the components shown in FIG. 1, and the assembly process itself may be better understood from the views provided in FIGS. 2, 2A, 2B, 2C, 2D, 2E and 3, which schematically and sequentially show all the steps pertaining to the main version of the inventive process.

The main version of the process herein disclosed comprises six basic steps, wherein step number 1 (such as shown in FIG. 2), starts with the spark plug wire 2, as originally produced, which is fully sectioned through a cutting operation that makes two wire segments designated by the reference numbers 2′ and 2″, and where segment 2′ is the segment that includes the socket 2A, while segment 2″ is the one that starts from coil 1.

Still as part of step number 1, components are positioned along wire segments 2′ and 2″, and as shown by arrows A and B in FIG. 2, in the end of the process, said components will actuate in the external protection of the region where the diode is mounted, and said components are the pipe-bridge 4 and the heat shrinkable cover 5.

Step number 2 of the main version of the process disclosed herein, shown in FIG. 2A, comprises, after fully cutting the spark plug cable 2, and after positioning the pipe-bridge 4 and heat shrinkable cover 5 along the respective wire segments 2′ and 2″, the step of reaming the two ends of the electrical conductor 6 which is part of the structure of the spark plug cable 2.

FIG. 2A shows a longitudinal section of the spark plug cable 2 already sectioned and with the ends of the electrical conductor 6 of each of the segments 2′ and 2″ already suitably reamed.

Step 3 of the main version of the process disclosed herein, as shown in FIG. 2B, comprises arranging a pipe sector 7 between the ends of the wire segments 2′ and 2″, inside which a diode unit 8 was previously housed.

Pipe sector 7 is sized in a way that the diode 8 is tightly positioned inside it, and also such that the ends or terminals 8A and 8B of said diode 8 exceed and protrude outwards the ends of said pipe sector 7.

The fact the ends or terminals 8A and 8B of the diode 8 protrude in respect of the pipe sector 7 allows for mounting said pipe sector 7 between segments 2′ and 2″ of the spark plug cable 2, and as a result, such terminals 8A and 8B forcedly get into direct contact with the corresponding segments of the electrical conductor 6 which are concentrically arranged in the spark plug cable 2, as clearly shown by arrows C in FIGS. 2B, 2C and 3.

Step number 4 of the main version of the process disclosed herein, such as the one shown in FIG. 2C, comprises the introduction of two adhesive layers 9 which are used to bond the pipe sector 7 to the respective segments 2′ and 2″ of the spark plug cable 2, one of said adhesive layers 9 being intended to bond each of the ends of said pipe sector 7 to its respective segment of the spark plug cable 2.

Step number 5 of the main version of the process disclosed herein comprises, as shown in FIG. 2D, sliding the pipe-bridge 4 to the mounting region of the pipe sector 7, as shown by arrow D, which is then positioned in order to exceed, by its two ends, the junction points between the pipe sector 7 and the ends of segments 2′ and 2″ of the spark plug cable 2.

The pipe-bridge 4 is sized such that to fit the outer diameter of segments 2′ and 2″, whose diameter size is the same as that of the pipe sector 7.

The function of said pipe-bridge 4 is to prevent the spark plug cable 2 from excessively bending in the region where the pipe sector 7 and segments 2′ and 2″ of the spark plug cable 2 get together, thereby protecting and keeping the integrity of the bonding points created between said pipe sector 7 and said segments 2′ and 2″, in addition to protecting the diode connection 8 and respective conductor sectors 6.

Step number 6 of the main version of the present assembly process comprises, as shown in FIG. 2E, sliding the heat shrinkable cover 5 into the mounting region of the pipe-bridge 4, as shown by arrow E, and said cover 5 being mounted in order to exceed, by its two ends, the ends of the pipe-bridge 4. After positioning said cover 5, this latter is subjected to some kind of heat source, thus causing it to shrink and thereby ensuring a steady junction with its mounting region.

The function of the heat shrinkable cover 5 is to improve the electrical insulation of the mounting region of diode 8, thus preventing current leakage from occurring in that region.

FIG. 3 shows a general section of the spark plug cable 2 and of the components aggregated thereto after being cut, said view allowing having an overall idea of the arrangement of all such components according to the main version of the present process.

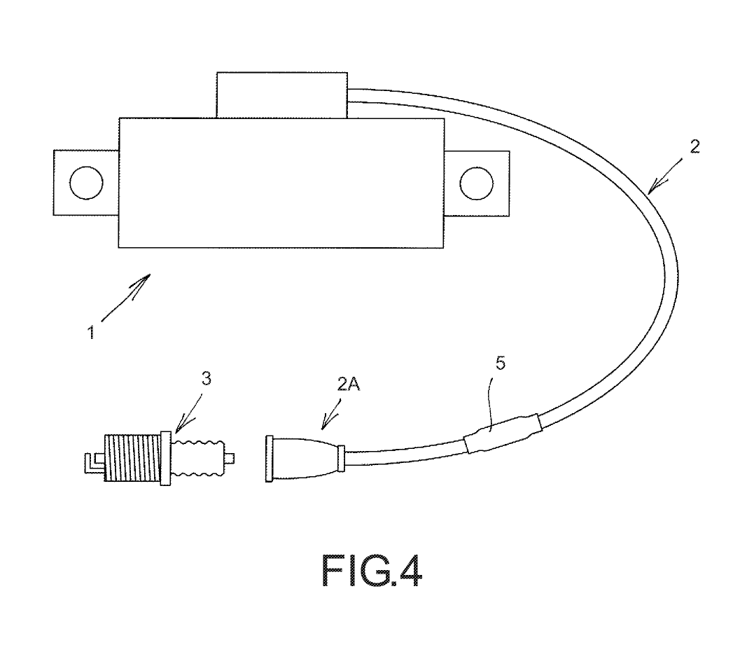

According to the main version of the process disclosed herein, FIG. 4 shows the finished assembly together with the power supply system of the spark plug 3, whose system comprises both said spark plug cable 2 and the coil 1.

The process disclosed herein allows properly assembling the diode 8 in a spark plug cable 2, whose assembly is made in order to keep the ideal conditions for operation of such component and further allows for obtaining a suitable reduction in the possibility of occurring leakage of part of the current going through said spark plug cable 2.

The process disclosed herein presents a first variation, the two first steps of which are the same as those of the main version, and for this reason, they require no specific illustrations.

Step number 1 (not specifically illustrated) of the first variation of the main version of the present process starts with the spark plug cable 2, as originally produced, fully sectioned through a cutting operation that produces two wire segments 2′ and 2″, as shown in FIG. 2 relating to step number 1 of the main version of the present process, where segment 2′ is the segment that includes the socket 2A, while segment 2″ is the one that starts from coil 1.

Still as part of step number 1 of the first variation of the main version of the present process, components are positioned along wire segments 2′ and 2″ (as seen in the same FIG. 2), which, in the end of the process, will actuate in the external protection of the region where the diode is mounted, whose components are the pipe-bridge 4 and heat shrinkable cover 5.

Step number 2 (not specifically illustrated) of the first variation of the main version of the process disclosed herein, and which is identical to the second step of said main version duly shown in FIG. 2A, comprises, after fully cutting the spark plug cable 2 and after positioning the pipe-bridge 4 and heat shrinkable cover 5 along the respective wire segments 2′ and 2″, the step of reaming the two ends of the electrical conductor 6 which is part of the structure of the spark plug cable 2.

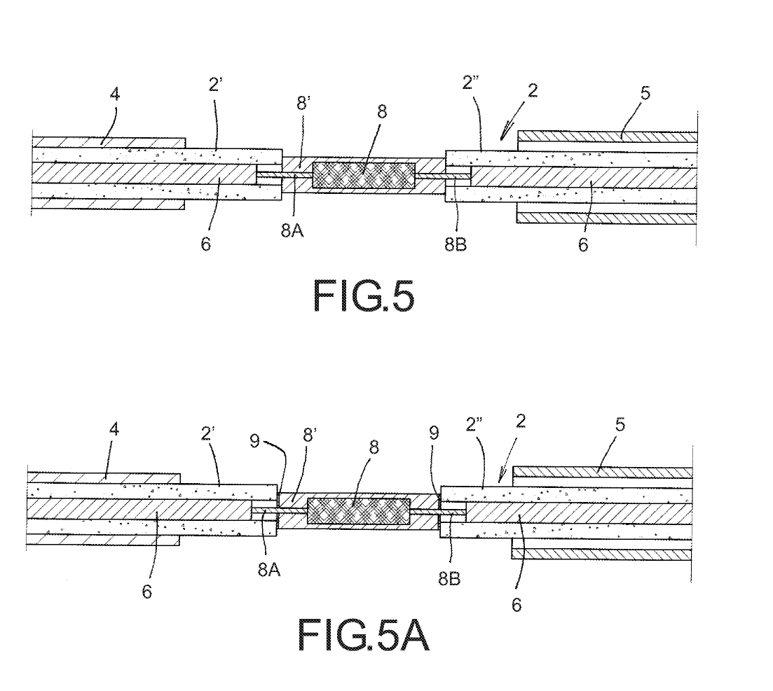

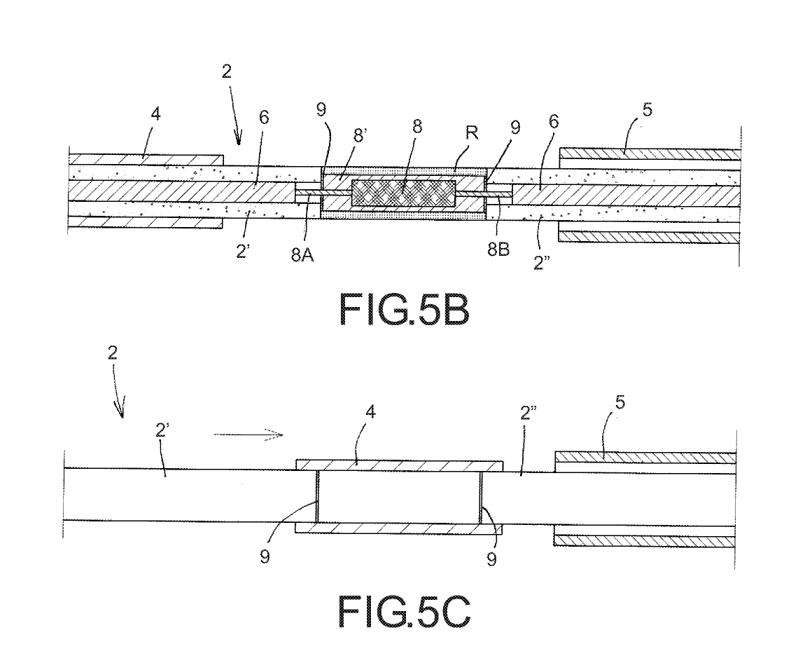

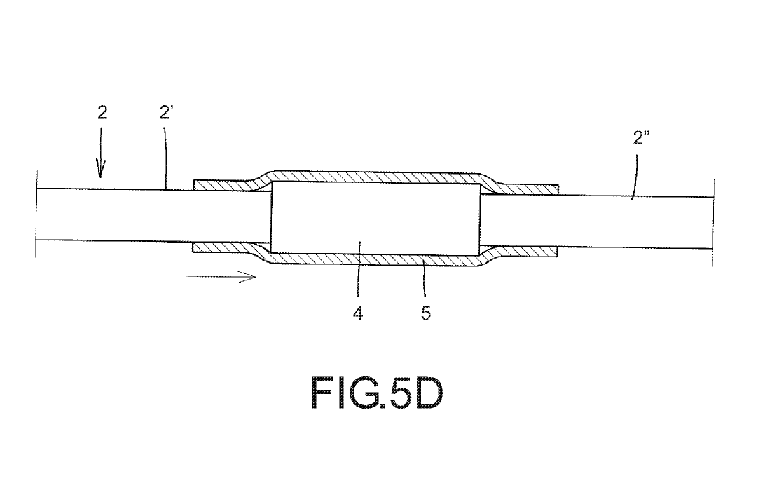

Step number 3 of the first variation of the main version of the process disclosed herein may be understood with reference to FIG. 5, where it can be noticed the fact that diode 8 is previously encapsulated through an overinjection process, said encapsulation producing a material wrapping layer 8′ which only keeps visible terminals 8A and 8B of diode 8.

In step number 4 of the first variation of the main version of the process disclosed herein, as shown in FIG. 5A, the two adhesive layers 9 are applied to bond the ends of the wrapping layer 8′ of diode 8 to the respective segments 2′ and 2″ of the spark plug cable 2.

In step number 5 of the first variation of the main version of the process disclosed herein, as shown in FIG. 5B, a resin R layer is applied around the wrapping layer 8′, and said resin layer is leveled in order to have an average measure as close as possible to that of the outer diameter of the spark plug cable 2.

Still according to the first variation of the main version of the process in question, after the resin layer R is applied, the sixth step of the process is taken, as shown in FIG. 5C, where a pipe-bridge 4 is mounted in the positioning region of the diode 8.

The seventh step of the first variation of the main version of the present process, as shown in FIG. 5D, comprises positioning a heat shrinkable cover 5 on the mounting region of the diode 8, said cover covering the pipe-bridge 5 and thus finishing the mounting.

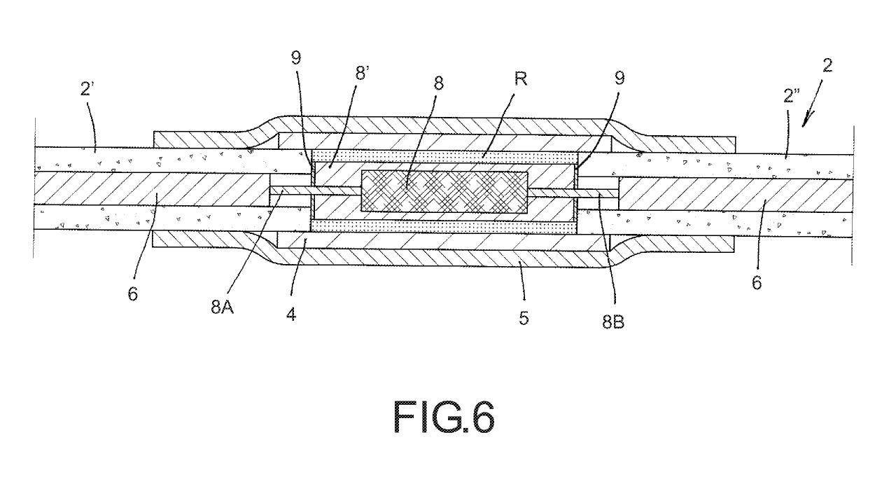

FIG. 6 shows, schematically, a general section of the portion of the spark plug cable subjected to the process of the invention, according to the first variation of the main version of this process, in which the diode 8 is mounted, and whose section allows viewing the aggregate of all components used in the mounting process.

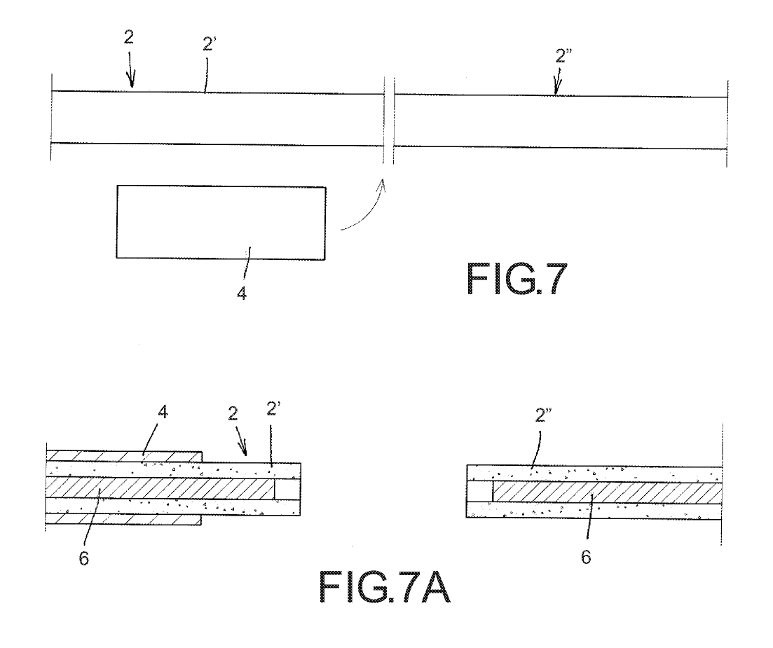

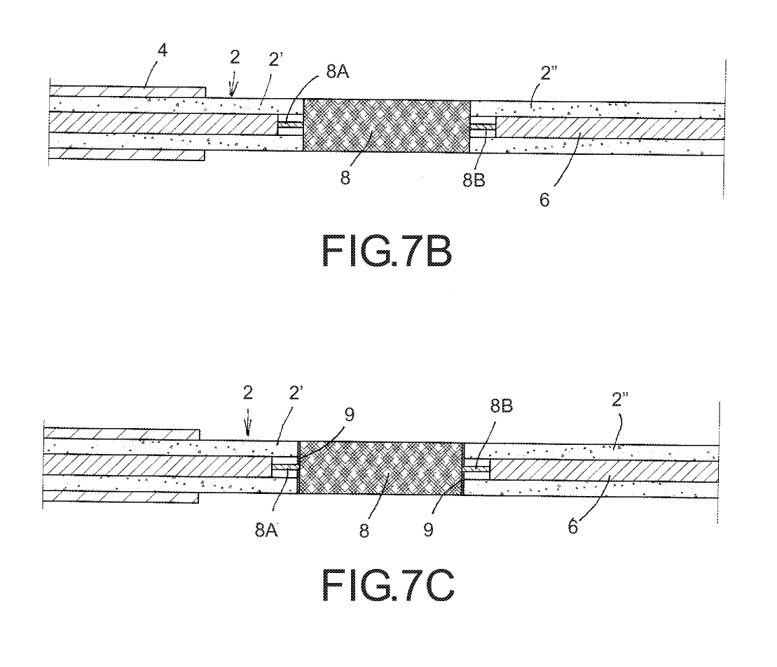

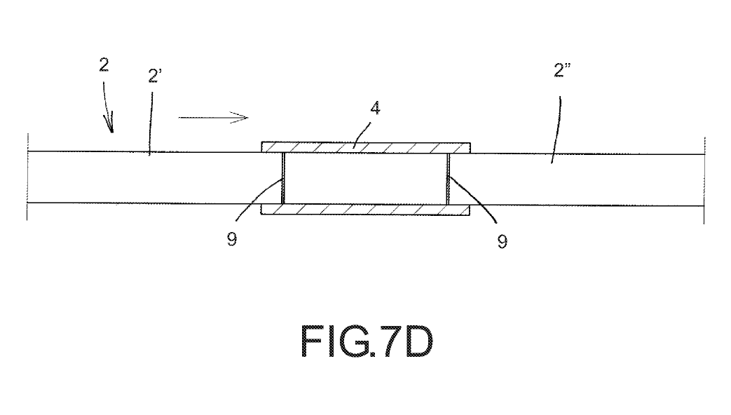

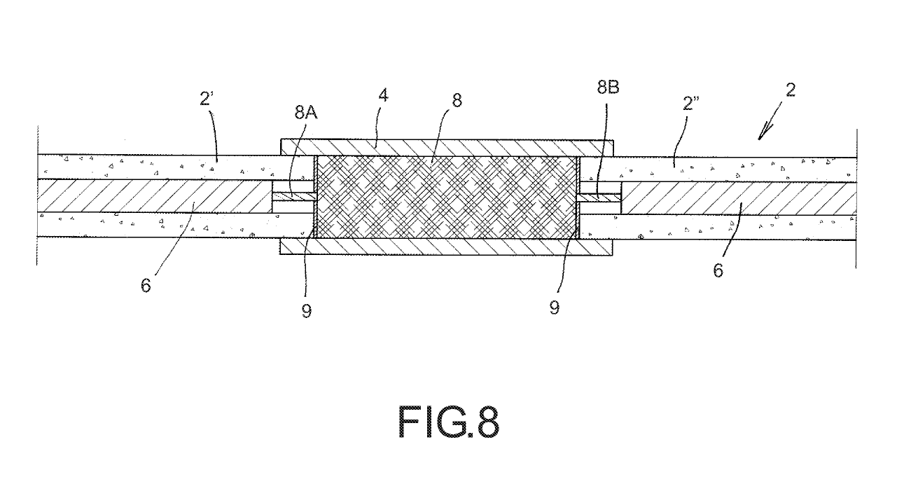

The process disclosed herein further comprises a second variation which may be understood by viewing FIGS. 7, 7A, 7B, 7C, 7D and 8.

In the mentioned FIG. 7, which shows the first step of said alternative process, it may be seen that the second variation of the main version of the process disclosed herein starts from the spark plug cable 2, as originally produced, which is fully sectioned through a cutting operation which makes two wire segments designated by reference numbers 2′ and 2″, and where segment 2′ is the segment that includes the socket 2A, while segment 2″ is the one that starts from coil 1.

Still as part of step number 1 of that alternative version shown in FIG. 7, the component positioned along wire segment 2′ is illustrated, which, in the end of the process, actuates in the external protection of the mounting region of diode 8, and said component is the pipe-bridge 4.

Step number 2 of the second variation of the main version of the process disclosed herein shown in FIG. 7A comprises, after fully cutting the spark plug cable 2, and after positioning the pipe-bridge 4 along the respective wire segment 2, the step of reaming the two ends of the electrical conductor 6 which is part of the structure of the spark plug cable 2.

FIG. 7A shows a longitudinal section of the spark plug cable 2 already sectioned and with the ends of the electrical conductor 6 of each of the segments 2′ and 2″ already suitably reamed.

Step number 3 of the second variation of the main version of the process disclosed herein, shown in FIG. 7B comprises arranging a diode 8 between the ends of the wire segments 2′ and 2″, the outer diameter of which being compatible with the diameter of the spark plug cable 2.

The diode 8 is positioned next to the wire segments 2′ and 2″ so that their terminals 8A and 8B forcedly get into direct contact with the corresponding segments of the electrical conductor 6 which are concentrically arranged in the spark plug cable 2.

Step number 4 of the second variation of the main version of the process disclosed herein, such as the one shown in FIG. 7C, comprises inserting two adhesive layers 9 used to bond the diode 8 to the respective segments 2′ and 2″ of the spark plug cable 2, one adhesive layer 9 intended to bond each of the ends of said diode 8 to its respective spark plug wire segment 2.

Step number 5 of the second variation of the main version of the process disclosed herein comprises, as shown in FIG. 7D, sliding the pipe-bridge 4 to the mounting region of the diode 8, said pipe-bridge being positioned in order to exceed, by its two ends, the junction points between the diode 8 and the ends of segments 2′ and 2″ of the spark plug cable 2.

The pipe-bridge 4 is sized so that it fits the outer diameter of segments 2′ and 2″, whose diameter is the same as that of the diode 8.

The function of said pipe-bridge 4 is to prevent the spark plug cable 2 from excessively bending in the region of the joint between the diode 8 and segments 2′ and 2″ of the spark plug cable 2, thereby safeguarding and protecting the integrity of the bonding points created between said diode 8 and said segments 2′ and 2″.

FIG. 8 shows a schematic view of a general section of the region of the spark plug cable 2 subjected to the process of the present invention, according to the second variation of the main version of the present process, where the diode 8 was mounted, whose section allows viewing the aggregate of all components used to render such mounting practical.

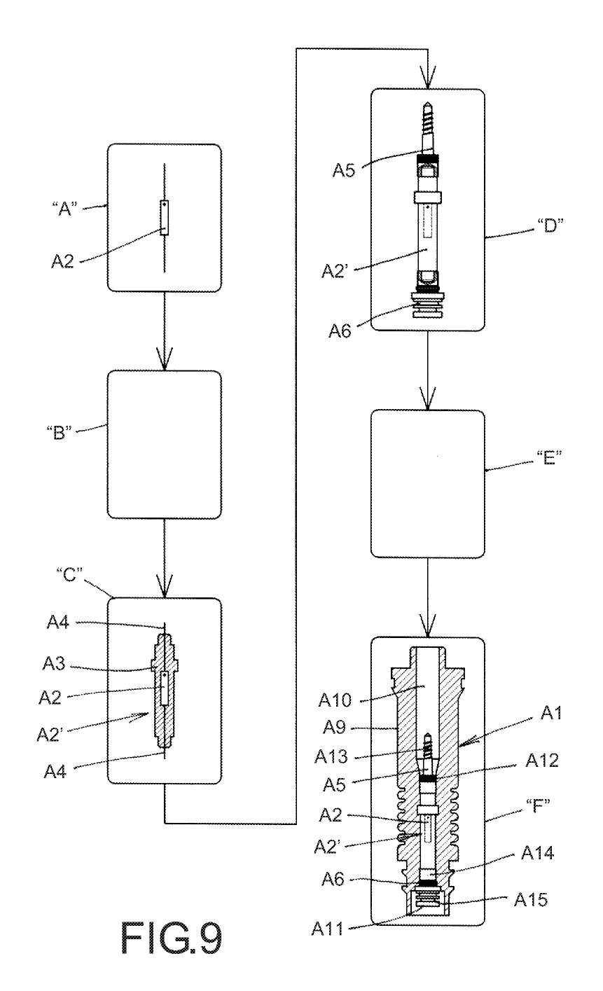

Another aspect provided in the present invention is the connector generally designated by the reference number A1, said connector being obtained by means of the process schematically shown in FIG. 9.

FIG. 9 shows a general view of the set of steps taken to produce the connector A1, whose steps start from the use of a diode unit A2, said diode unit depicted in block “A” of said FIG. 9.

The diode unit A2 is subjected to a first injection step depicted by block “B” of FIG. 9, and said injection step produces an encapsulated diode A2′, which results from the diode unit A2 being suitably coated with a full plastic covering A3, and only terminals A4 of the mentioned diode unit A2 stay outside said covering. The production of the encapsulated diode A2′ is shown in block “C” of FIG. 9.

The next step of the process described herein (block “D”) comprises mounting the encapsulated diode A2′ between two metal terminals A5 and A6, which are connected to the ends of the mentioned encapsulated diode A2′ so that its terminals A4 take on an electrical connection condition with the metal terminals A5 and A6.

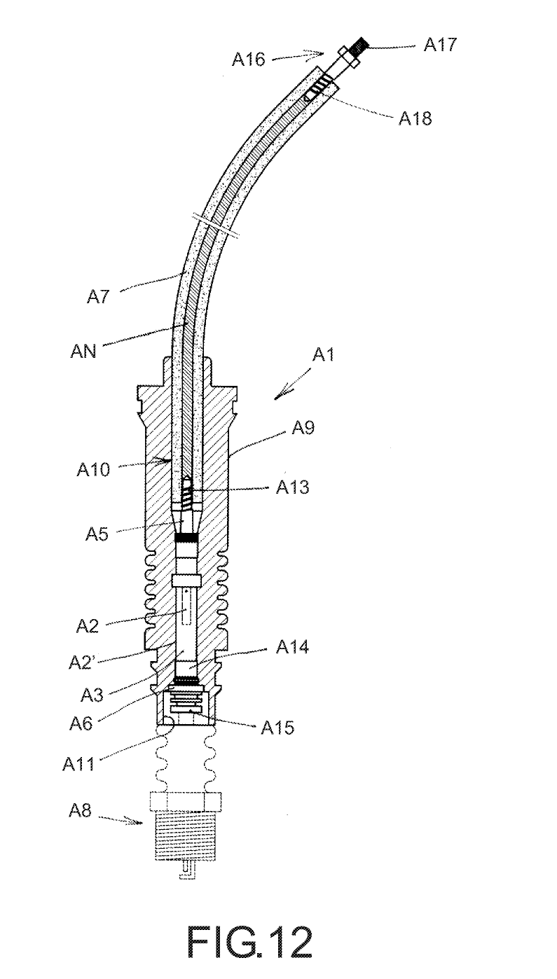

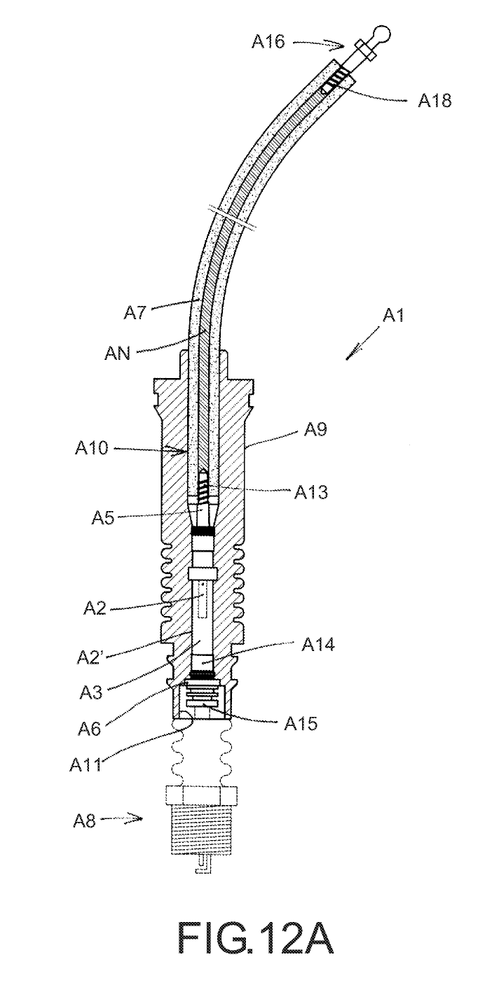

Said metal terminals A5 and A6 are components which allow the resistive connector A1 disclosed herein to contact, on one hand, with the spark plug cable A7 (not shown in FIG. 9), and on the other hand, with the spark plug A8, as shown in FIG. 12.

After assembly, the encapsulated diode A2′ is subjected to step “E” of the present process, according to which the assembly comprised by the encapsulated diode A2″ and terminals A5 and A6 aggregated thereto is arranged in a specific pattern so that said component assembly may then be subjected to a new injection step.

The assembly of the encapsulated diode A2′ is depicted by block “D” of FIG. 9, while the second injection step itself, which is performed over said assembly comprised by the encapsulated diode A2′ and terminals A5 and A6, is schematically shown in block “E”.

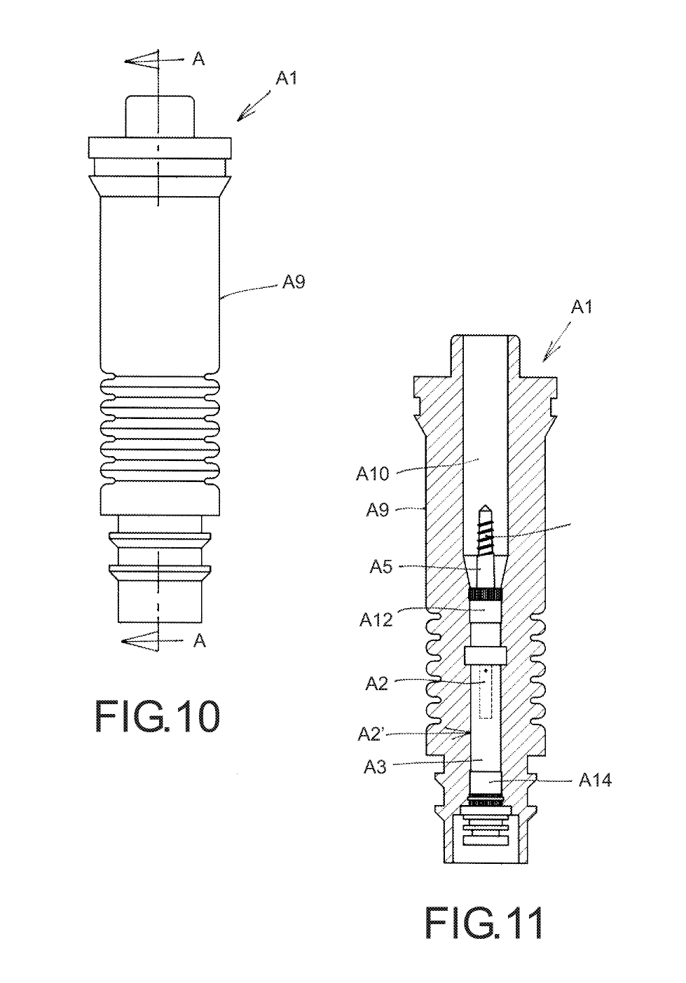

After the second injection step is complete, the resulting product already configures the connector A1 as schematically shown in block “F” of the same FIG. 9 and still according to what is shown in FIGS. 10, 11 and 12.

The manufacturing process described above produces connector A1, which is also one of the objects disclosed in this invention.

As already mentioned herein, connector A1 is designed and manufactured to receive, by one of its ends, the suppression spark plug cable A7, while the opposite end of the connector is designed to allow for its direct connection to the spark plug A8.

After the second injection step, the connector A1 takes on an one-piece body A9 having an input channel A10 designed to receive the end of the suppression spark plug cable A7, as well as an opposite channel A11 through which the connection with the spark plug terminal A8 is made.

In order to obtain such connection effect with the suppression spark plug cable A7, the terminal A5 previously mounted in the encapsulated diode A2′ comprises a mounting base A12 which is directly mounted by interference next to the corresponding end of the encapsulated diode A2′, thus getting into contact with the respective terminal A4 of the diode unit A2.

The terminal A5 further features a threaded head A13, which is typically shaped as a standard self-tapping screw.

The threaded head A13 is outlined in order to allow the end of the suppression spark plug cable A7 to be screwed directly thereto, which leads the threads of said threaded head A13 to get into contact and attach to the metal mesh of the conductor core AN of the suppression spark plug cable A7, whose condition is schematically shown in FIGS. 12 and 12A.

Terminal A6 that is fastened to the opposite end of the encapsulated diode A2′ features a mounting base A14, which, as occurs with the mounting base A12 of terminal A5, is directly mounted, by interference, in the corresponding end of the encapsulated diode A2′ and gets into contact with the terminal A4 of the diode unit A2.

Contrary to what happens with terminal A5, terminal A6 features no threaded head, but a standardized connection terminal A15 suitably built to allow its assembly in the spark plug terminal A8.

FIG. 10 shows terminal A1 in its final condition, i.e., after the second injection step is complete, while FIG. 11 shows a full section of the same terminal, and said illustration allows viewing the entire internal construction of the components assembled inside said terminal A1.

FIG. 12 provides a schematic view of terminal A1 suitably positioned and connected intermediately between a suppression spark plug cable A7 and a spark plug A8.

Said FIG. 12 further includes the provision of an end terminal A16, which is screwed directly to the conductor core of the suppression spark plug cable A7, said terminal A16 features an head A17 provided with continuous annular ribs or grooves whose pattern is similar to that of the spark plug terminal A8, thus allowing for the original socket (not shown) to be connected thereto, said end terminal A16 further featuring an threaded projection A18, which, similarly to what is seen in connection with the threaded head A13, allows its threads to get into contact and attach to the mesh of core AN of the spark plug cable A7.

FIG. 12A shows a schematic view of another connector modality shown in FIG. 12, said variation being configured in order to include a head A17 compatible with the standard pin popularly known as “powder fuse”.

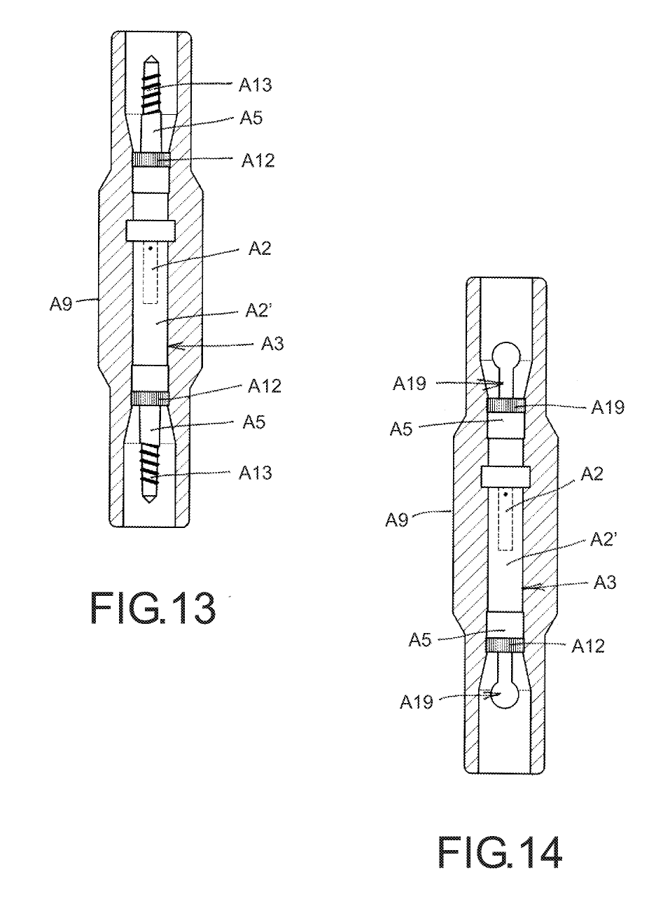

FIGS. 13 and 14 show two other variations of the connector A1 object of this invention, in which FIG. 13 shows a connector modality intended to be used with non-resistive suppression spark plug cables typically used in motorcycles and similar vehicles, while FIG. 14 shows another variation of this connector, which is intended to be used with resistive suppression spark plug cables for use in cars and similar vehicles.

Connector A1 (not shown) of FIG. 13 features the same metal terminal A5 shown in FIGS. 12 and 12A, except that this type of connector is provided in the two ends of connector A1, and not only in one of them.

FIG. 14 shows another sample of connector A1, which is a variation of connector A1 of FIG. 13, and it is different because it includes a metal terminal A19 designed according to the pin standard known as “powder fuse”.

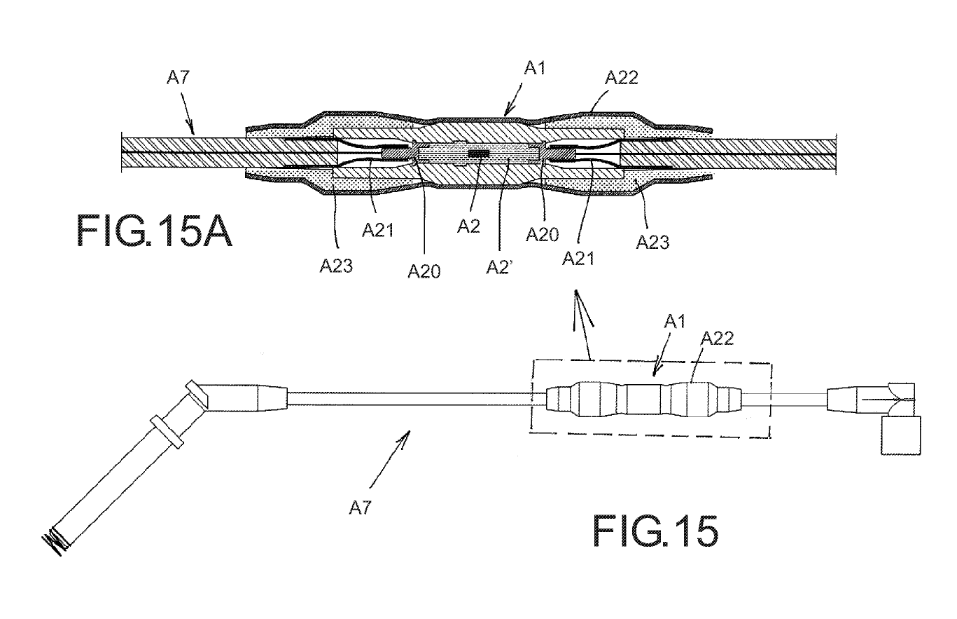

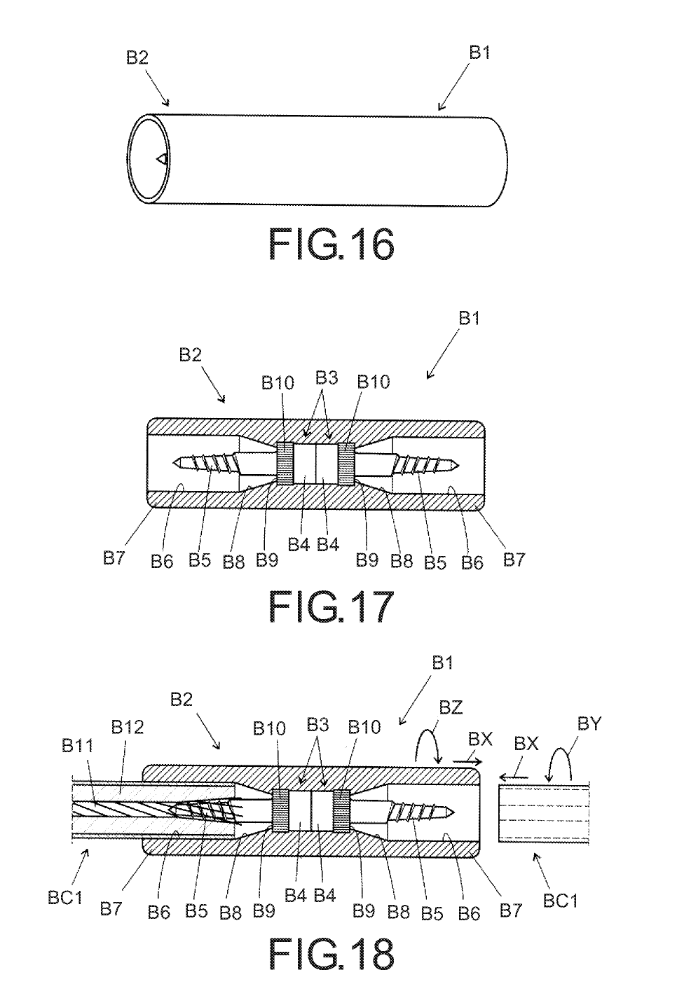

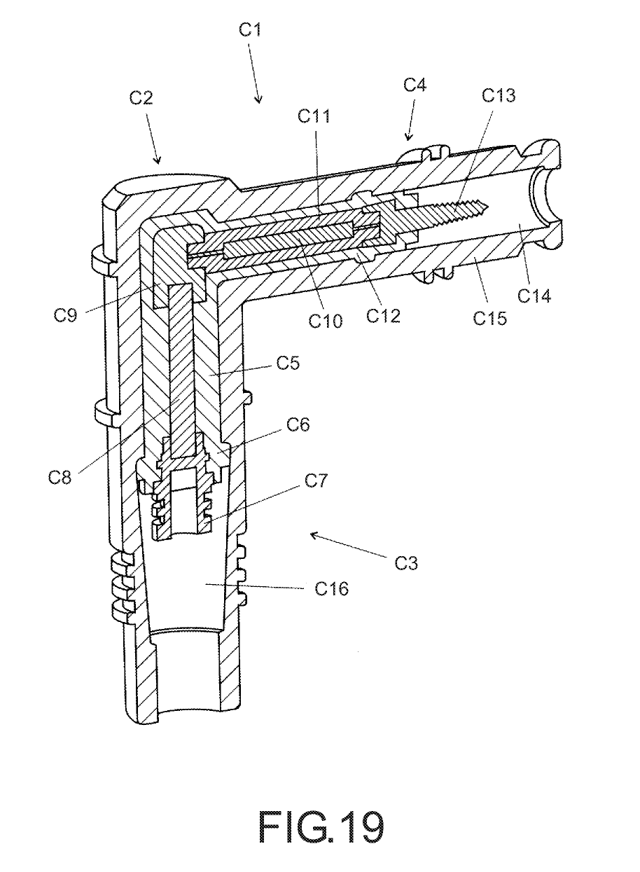

FIG. 15 shows connector A1 disclosed herein directly assembled in a suppression spark plug cable A7; said suppression spark plug cable A7 being designed to include connector A1 in its structure during manufacturing, connector A1 being provided with a diode unit A2, which (as specifically shown in FIG. 15A) is suitably encapsulated thus defining an encapsulated diode unit A2′, which receives, in each of its ends, a terminal A20 which gets into contact with a connection component A21 which is connected to the core of the spark plug cable A7; said version of connector A1 is suitably protected by an external covering A22, which overlaps, in its ends, the closing components A23 surrounding the external wall of the spark plug cable A7.

The present invention further provides another connector modality for the spark plug cable, which is generally designated by the reference number B1 and characterized in that it is intended to allow both the electrical connection between the two cable sectors, shown as BC1 and BC2, and also, in a simple and effective way, that such connection is made in a condition under which an ideal mechanical resistance is established between said cable sectors BC1 and BC2.

Therefore, connector B1 disclosed herein is essentially defined as a main cylindrical body made of injected material, inside which two metal inserts are mounted in a centralized, mutual opposition arrangement, each of said two metal inserts featuring a mutual contact terminal B4, and a self-tapping screw-shaped terminal B5 mounted to their respective opposite ends.

The main cylindrical body B2 of connector B1 is preferably but not exclusively obtained by injection performed around the pair of metal inserts B3.

The main cylindrical body B2 is defined by featuring coaxial cavities B6 in each of its ends B7, said coaxial cavities B6 having a circular section outline in approximately ⅔ of their total length, and in the last ⅓ of their length, the diameter of cavities B6 is reduced, thus creating a trunk-conical section B8 which converges to a point from which the respective metal inserts B3 start, as it may be better understood by looking at FIGS. 17 and 18.

Metal inserts B3 are mounted in mutual opposition, and are held in the middle of the material of which the main body B2 is made, upon the provision of two retention edges B9 defined in the limit of each of the trunk-conical sections B8, which establish the direct contact with the front edge of each of the mutual contact terminals B4.

Each of the mutual contact terminals B4 further includes a pattern of parallel ribs B10 that expand the contact area between the metal surface of said portion of the metal inserts B3 and the material that forms the main body B2, said parallel ribs B10 also serving to ensure steady junction between said components, thus particularly preventing the metal inserts B3 from having any rotation movement in respect of the geometric axis of the main body B2 of said connector B1.

Because of its design solution, the construction of connector B1 is simple, less expensive and may be manufactured in large scale.

The use of connector B1 in order to join two sectors of the spark plug cable can be understood by reference to FIG. 18, where a section of a sample of said connector is shown and illustrated.

The above-mentioned FIG. 18 shows the spark plug cable sector BC1 in its final assembly, while the other spark plug cable sector BC2 is shown relatively apart.

Still referring to FIG. 18, the arrows depict the movement required for connecting the spark plug cable sector to the connector body, where two arrows “X” are visible showing a mutual approach movement that must be performed to establish the connection between the cable sector (BC2) and the connector B1; and an arrow “Y” can also be seen showing the rotation movement of the cable sector in respect to the connector B1, while a corresponding arrow “Z” (in opposite direction to that seen with regard to arrow “Y”) is shown around said connector B1.

Arrows “X”, “Y” and “Z” show that in order to connect a sector of a spark plug cable (BC1 or BC2) to the connector B1, movements must be simultaneously performed to approach the cable sector to the respective coaxial cavity B6 of the main body B2, at the same time that after said end of the mentioned cable sector is introduced into said coaxial cavity B6, a rotation movement (in opposite directions) must be applied to both the cable sector itself, and the connector B1.

The above-mentioned rotation movement causes the self-tapping screw-shaped terminal B5, when contacting the bundle of metal cables B11 arranged in the centre of core B12 of the cable sector, to screw directly to such cable bundle B11.

The rotating introduction of said self-tapping screw-shaped terminal B5 between the cables B11 simultaneously produces both the electrical connection between the connector B1 and the mentioned cable sector, and also establishes a mechanical connection between the cable sector and the central portion of the main body B2 of connector B1.

When the above operation is repeated for the two cable sectors BC1 and BC2, a simple and quick restoration of the original ideal conditions for electrical transmission and mechanical resistance of the spark plug cable is obtained.

As shown in the description and drawings disclosed herein, the connector B1 may be simply and effectively used for joining the two sectors of the spark plug cable, and no kind of tool is required for such purpose.

The present invention further provides a socket modality, generally designated by the reference number C1, which comprises a main, one-piece structure C2, which is divided in two mutually angularly arranged portions, said angle being preferably but not solely defined as a 90-degree angle.

The first portion of the one-piece structure C2 designated by the reference number C3 corresponds to the end that is directly mounted next to the terminal of the spark plug (not shown), while the second portion designated by the reference number C4 corresponds to the portion where the spark plug cable itself (not shown) is mounted.

The one-piece structure C2 receives internally an injected core C5 equally divided in two portions mutually angularly arranged, said angle being preferably but not solely defined as a 90-degree angle; said core C5 comprising a first portion C6 which encapsulates a connector C7 in its end, which contacts the spark plug terminal (not shown); said connector C7 typically features a locking spring (not shown since this is a conventional component).

A resistor C8 is further provided inside the first portion C6 of the injected core C5, where the resistor is mounted and encapsulated between the connector C7 and an angular connector C9, preferably but not solely designed to establish a 90-degree angle connection, which is connected, at its other side, to a diode C10, which is previously encapsulated in an injected coating C11, said diode C10 and its coating C11 being arranged inside the second portion C12 of core C5.

The second portion C12 of core C5 receives and encapsulates at its end a union screw C13, which is exposed in a tubular cavity C14 provided in the end C15 of the one-piece structure C2. The union screw C13 is mounted in order to establish an electrical connection with the diode terminal C10.

An equal tubular cavity analogous to the tubular cavity C14, but designated by the reference number C16 is also provided in the first portion C3 of the same structure C2, thus allowing to keep the connector C7 and the spark plug terminal coupling (not shown) fully protected.

At the opposite end, said tubular cavity C14 receives the end of the spark plug cable (not shown), which is inserted into said tubular cavity C14 and then screwed so that thread C13 is attached by its threads next to the core of said spark plug cable.

The socket C1 disclosed herein combines the known improvement in performance achieved by the use of a diode C10 and a particularly advantageous arrangement from the standpoint of manufacturing the socket for the spark plug.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A process for assembly of a diode in a spark plug cable of an internal combustion engine, whose purpose is to assemble a diode (8) in a spark plug cable (2) of the type that is connected, on one hand to a spark plug (3), and on the other, to a coil (1), such spark plug (2) further featuring a socket (2A), wherein the main version of said assembly process is characterized by comprising a step number 1, which starts from the spark plug (2), such as originally produced, said spark plug cable (2) being fully sectioned by means of a cutting operation that makes two wire segments designated by the reference numbers (2′) and (2″), and where segment (2′) is the segment that includes the socket (2A), while segment (2″) is the segment that starts from coil (1); still as part of step number (1), components are positioned along the wire segments (2′) and (2″), which, in the end of the process, will actuate in the external protection of the mounting region of the diode (8), whose components are the pipe-bridge (4) and heat shrinkable cover (5); said process further providing a step number 2, which comprises, after fully cutting the spark plug cable (2) and positioning the pipe-bridge (4) and the heat shrinkable covering (5) along the respective wire segments (2′) and (2″), the step of reaming the two ends of the electrical conductor (6) which is part of the structure of the spark plug cable (2); said process further comprising a step number 3, which comprises arranging a pipe sector (7) between the ends of the wire segments (2′) and (2″), inside which a diode unit (8) has been previously housed; said process further provides a step number 4, which comprises introducing two adhesive layers (9) used to bond the pipe sector (7) to the respective segments (2′) and (2″) of the spark plug cable (2); said process further provides a step number 5, which comprises sliding the pipe-bridge (4) into the mounting region of the pipe sector (7), this latter being positioned in such way to exceed, by its two ends, the junction points between the pipe sector (7) and the segment ends (2′) and (2″) of the spark plug cable (2); said process further provides a step number 6, which comprises sliding the heat shrinkable cover (5) into the mounting region of the pipe-bridge (4), such cover (5) being mounted in such a way to exceed, by its two ends, the ends of the pipe-bridge (4).

2. The process for assembly of a diode in a spark plug cable of an internal combustion engine, according to claim 1, characterized in that the pipe sector (7) is sized such that the diode (8) is tightly positioned inside it and also such that the ends or terminals (8A) and (8B) of such diode (8) exceed and protrude outwards the ends of said pipe sector (7).

3. The process for assembly of a diode in a spark plug cable of an internal combustion engine, according to claim 1, characterized in that the ends or terminals (8A) and (8B) of the diode (8) protrude in relation to the pipe sector (7), they allow for the assembly of said pipe sector (7) between segments (2′) and (2″) of the spark plug cable (2), such terminals (8A) and (8B) forcedly get into direct contact with the corresponding segments of the electrical conductor (6) which are concentrically arranged in the spark plug cable (2).

4. The process for assembly of a diode in a spark plug cable of an internal combustion engine, according to claim 1, characterized in that the pipe-bridge (4) is sized to fit the outer diameter of segments (2′) and (2″) of the spark plug cable (2), whose diameter is the same as that of the pipe sector (7).

5. The process for assembly of a diode in a spark plug cable of an internal combustion engine, according to claim 1, characterized in that the function of said pipe-bridge (4) is to prevent the spark plug cable (2) from excessively bending in the region of the joint between the pipe sector (7) and segments (2′) and (2″) of the spark plug cable (2), thereby safeguarding and protecting the integrity of the bonding points created between the mentioned pipe sector (7) and said segments (2′) and (2″), besides further keeping and protecting the diode connection (8) and respective conductor sectors (6).

6. The process for assembly of a diode in a spark plug cable (2) of an internal combustion engine, according to claim 1, characterized in that the function of the heat shrinkable cover (5) is to provide electrical insulation to the mounting region of the diode (8).

7. The process for assembly of a diode in a spark plug cable of an internal combustion engine, according to claim 1, characterized in that the process disclosed herein provides a first variation, whose step number 1 starts from the spark plug cable (2), such as originally produced, which is fully sectioned by means of a cutting operation, thus making two wire segments (2′) and (2″), of which segment (2′) is the segment that includes the socket (2A), while segment (2″) is the one that starts from the coil (1); still as part of step number 1 of the first variation of the main version of the present process components are positioned along wire segments (2′) and (2″), whose components, in the end of the process, actuate in the external protection of the mounting region of the diode (8), said components being the pipe-bridge (4) and the heat shrinkable cover (5); the first variation of the main version of the present process provides a step number 2, which comprises, after fully cutting the spark plug cable (2), and positioning the pipe-bridge (4), and also the heat shrinkable cover (5) along the respective wire segments (2′) and (2″), the step of reaming the two ends of the electrical conductor (6) which starts from the spark plug cable (2); this first variation of the main version of the process disclosed herein provides the use of a diode (8) previously encapsulated through an overinjection process, said encapsulation generating a material wrapping layer (8′) which keeps visible terminals (8A) and (8B) only; the first variation of the main version of the process disclosed herein comprises a step number 4, which consists of applying two adhesive layers (9) used to bond the ends of the wrapping layer (8′) of the diode (8) to the respective segments (2′) and (2″) of the spark plug cable (2); step number 5 of the first variation of the main version of the process disclosed herein consists of applying a resin layer (R) around the wrapping layer (8′) of the diode (8), whose resin layer (R) is leveled to show an average measure as close as possible to that of the outer diameter of the spark plug cable (2); still according to the first variation of the main version of the mentioned process, after applying the resin layer (R), the sixth step is carried out, which comprises positioning a pipe-bridge (4) in the mounting region of the diode (8); the seventh step of the first variation of the main version of the present process comprises positioning a heat shrinkable cover (5) on the mounting region of the diode (8), which covers the pipe-bridge (4) and thus completes the mounting.

8. The process for assembly of a diode in a spark plug cable (2) of an internal combustion engine, according to claim 1, characterized in that the process disclosed herein further comprises a second variation which starts from the spark plug cable (2), such as originally produced, which is fully sectioned by means of a cutting operation that thus makes two wire segments designated by the reference numbers (2′) and (2″) and where segment (2′) is the segment that includes the socket (2A), while segment (2″) is the segment that starts from coil (1); still as part of step number (1) of this alternative version of the present process, a component is positioned along wire segments (2′), which, in the end of the process, actuates in the external protection of the mounting region of the diode (8), whose component is the pipe-bridge (4); the second variation of the main version of the process disclosed herein comprises, after fully cutting the spark plug cable (2) and also positioning the pipe-bridge (4) along the respective wire segment (2′), reaming the two ends of the electrical conductor (6) which is part of the structure of the spark plug cable (2); step number 3 of the second variation of the main version of the process disclosed herein, comprises arranging a diode (8) between the ends of the wire segments (2′) and (2″), whose outer diameter is compatible with the diameter of the spark plug cable (2); the diode (8) is positioned next to the wire segments (2′) and (2″) such that its terminals (8A) and (8B) get into direct contact with the corresponding segments of the electrical conductor (6) which are concentrically arranged in the spark plug cable (2); step number 4 of the second variation of the main version of the process disclosed herein comprises introducing two adhesive layers (9) used to bond the diode (8) to the respective segments (2′) and (2″) of the spark plug cable (2), the adhesive layer (9) being intended to bond each of the ends of said diode (8) to its respective spark plug wire segment (2); step number 5 provided in the second variation of the main version of the process disclosed herein, comprises sliding the pipe-bridge (4) into the mounting region of the diode (8), this latter being positioned in such way to exceed, by its two ends, the junction points between the diode (8) and the segment ends (2′) and (2″) of the spark plug cable (2).

9. A suppression spark plug cable connector, which is generally designated by the reference number (A1) and internally includes a diode (A2) mounted in an encapsulated way (A2′), such connector (A1) being characterized in that it is manufactured to receive a suppression spark plug cable (A7) by one of its ends, while its opposite end is designed to allow for its direct connection with the spark plug (A8); the connector (A1) has an one-piece body (A9), with an input channel (A10) intended to receive the end of the suppression spark plug cable (A7), as well as an opposite channel (A11), through which the connection with the spark plug terminal (A8) is made; the terminal (A5) previously mounted in the encapsulated diode (A2′) comprises a mounting base (A12) which is directly mounted by interference next to the corresponding end of the encapsulated diode (A2′), thus getting into contact with the respective terminal (A4) of the diode unit (A2); the terminal (A5) further features a threaded head (A13) shaped as a standard self-tapping screw; the threaded head (A13) is defined in order to allow the end of the suppression spark plug cable (A7) to be directly screwed thereto, and this fact causing the threads of said threaded head (A13) to get into contact with and attach to the metallic mesh of the conductor core (AN) of the suppression spark plug cable (A7); the terminal (A6) which is aggregated to the opposite end of the encapsulated diode (A2′) features a mounting base (A14), which, as verified with the mounting base (A12) of the terminal (A5), is directly mounted, by interference, next to the corresponding end of the encapsulated diode (A2′) and contacts the terminal (A4) of the diode unit (A2); the terminal (A6) having a standardized connection terminal (A15) built to allow being mounted in the spark plug terminal (A8).

10. The suppression spark plug cable connector, according to claim 9, characterized in that the connector (A1) expects the use of an end terminal (A16), which is screwed directly to the conductor core of the suppression spark plug cable (A7), such terminal (A16) featuring a head (A17) provided with continuous annular ribs or grooves whose design is analogous to that of the spark plug terminal (A8), said end terminal (A16) further featuring a threaded projection (A18), which allows its threads to get into contact with and attach to the mesh of the core (AN) of the spark plug cable (A7).

11. The suppression spark plug cable connector, according to claim 9, characterized in that the connector (A1) has a construction variation, which includes a head (A17) compatible with the pin standard known as “powder fuse”.

12. The suppression spark plug cable connector, according to claim 9, characterized in that the connector (A1) has a construction variation intended to be used with non-resistive suppression spark plug cables; the connector (A1) including the same kind of metal terminal (A5) at its two ends.

13. The suppression spark plug cable connector, according to claim 9, characterized in that the connector (A1) has a construction variation intended to be used with resistive suppression spark plug cables; the connector (A1) including a metal terminal (A 19) shaped according to the standard pin known as “powder fuse”.

14. The suppression spark plug cable connector, according to claim 9, characterized in that the connector (A1) disclosed herein may be directly included into a suppression spark plug cable (A7), and the encapsulated diode unit (A2′) of the connector (A1) receiving, in each of its end, a terminal (A20) which gets into contact with a connection component (A21) which is connected to the core of the spark plug cable (A7), said version of the connector (A1) being suitably protected by an external covering (A22), which overlaps, in its ends, the closing components (A23) surrounding the external wall of the spark plug cable (A7).

15. A manufacturing process of a suppression spark plug cable connector, such process employed to produce a connector for a suppression spark plug cable (A1), as described in claim 14, the process disclosed herein being characterized in that it provides a number of steps starting from the use of a diode (A2)—block “A”; the diode unit (A2) being submitted to a first injection step represented as block “B”, said injection step generating an encapsulated diode (A2′), which results from the diode unit (A2) being suitably coated with a full covering (A3) preferably made of plastic material, and only terminals (A4) of the mentioned diode unit (A2) are left outside said covering, and the obtainment of the encapsulated diode (A2′) corresponds to block “C” step; the next step of the process disclosed herein—block “D”, comprising mounting the encapsulated diode (A2′) between two metal terminals (A5) and (A6), which are connected to the ends of said encapsulated diode (A2′) such that the terminals (A4) thereof establish an electrical connection with the metal terminals (A5) and (A6); after mounting the encapsulated diode (A2′)—block “D”, it is subjected to step “E” of the present process, where the assembly consisting of the encapsulated diode (A2′) and terminals (A5) and (A6) aggregated thereto is arranged in a specific mold so that said component assembly may then be subjected to a new injection step; after the second injection step is complete, the resulting product is the connector (A1)—block “F”.

16. The manufacturing process of a suppression spark plug cable connector, according to claim 15, characterized in that in an alternative assembly of the terminal (A1), the process provides using two metal terminals (A5) connected to the ends of the encapsulated diode (A2′).

17. The manufacturing process of a suppression spark plug cable connector, according to claim 15, characterized in that in an alternative mounting of the terminal (A1), the process provides using two metal terminals (A19) connected to the ends of the encapsulated diode (A2′).

18. A spark plug cable connector, which is a connector for a suppression spark plug cable and that is generally designated by the reference number (B1), characterized in that it is intended to allow both the electrical connection between the two cable sectors, designated as (BC1) and (BC2), and also allow such connection to be made in a condition where an ideal mechanical resistance is established between the mentioned cable sectors (BC1) and (BC2); the connector (B1) is essentially defined as a main cylindrical body (B2) made of injected material, inside which two metal inserts (B3) are centrally mounted in mutual opposition, each of said inserts having a mutual contact terminal (B4) and at its respective opposite ends, a self-tapping-shaped screw terminal (B5); the main cylindrical body (B2) of the connector (B1) being produced preferably but not solely by means of injection around the pair of metal inserts (B3); the main cylindrical body (B2) is defined by featuring a coaxial cavity (B6) in each of its ends (B7), said coaxial cavities (B6) having a circular section outline in ⅔ of their total length, and in the last ⅓ of such length measure, the diameter of the cavities (B6) is reduced thus creating a trunk-conical section (B8) converging towards a point from which the respective metal inserts (B3) start; the metal inserts (B3) are mounted in mutual opposition, and are held in the middle of the material of which the main body (B2) is made upon provision of two retention edges (B9) defined in the limit of each of the trunk-conical sections (B8), which establish a direct contact with the front edge of each of the mutual contact terminals (B4).

19. The spark plug cable connector, according to claim 18, characterized in that each of the mutual contact terminals (B4) further includes a pattern of parallel ribs (B10) that expand the contact area between the metal surface of said portion of metal inserts (B3) and the material of which the main body (B2) is made, said parallel ribs (B10) ensuring steady junction between said components, thus particularly preventing the metal inserts (B3) from having a rotation movement in respect of the geometric axis of the main body (B2) of connector (B1).

20. The spark plug connection socket for internal combustion engines, said socket being designated by the reference number (C1) and comprising a main, one-piece structure (C2), which is divided in two portions mutually arranged at an angle, said socket (C1) further comprising a first portion of the one-piece structure (C2), designated by the reference number (C3), which corresponds to the end that is directly mounted next to the spark plug terminal, as well as a second portion (C4) corresponding to the portion that receives the mounting of the spark plug cable itself, the referred to socket (C1), characterized in that the one-piece structure (C2) receives internally a core also injected (C5) equally divided in two portions mutually arranged at an angle, said core (C5) comprising a first portion (C6), which encapsulates in its end a connector (C7), which contacts the spark plug terminal; a resistor (C8) is further provided inside the first portion (C6) of the injected core (C5), and the resistor is mounted and encapsulated between the connector (C7) and an angular connector (C9), which, at its other side, is connected to a diode (C10), which is previously encapsulated in an injected coating (C11), said diode (C10) and its coating (C11) being arranged inside the second portion (C12) of the core (C5); the second portion (C12) of the core (C5) receives and encapsulates in its end a union screw (C13), which is exposed in a tubular cavity (C14) provided in the end (C15) of the one-piece structure (C2); an equal tubular cavity (C16) is also provided in the first portion (3) of the same structure (2), thus allowing the coupling between the connector (C7) and the spark plug terminal is fully protected.
